(19) United States
(12) Patent Application Publication
(10) Pub. No.: US 2002/0187309 A1
(43) Pub. Date: Dec. 12, 2002

(54) Two- or multi-colored foam foil, method as well as device for its manufacture

(76) Inventors: Eberhard Rost, Aalen (DE); Jurgen Buhring, Burgwedel (DE)

Correspondence Address: FAY, SHARPE, FAGAN,, MINNICH & McKEE, LLP, 1100 Superior Avenue, Seventh Floor, Cleveland, OH, 44114-2518, US

(21) Appl. No.: 10/137,538

(22) Filed: May 2, 2002

(30) Foreign Application Priority Data
May 3, 2001 (DE) DE 101 21 518.5

(51) Int. Cl. B32B 3/00; B29C 47/06

(52) U.S. Cl. 428/172; 264/46.1; 264/135; 264/173.11; 264/173.18; 264/284; 425/363; 425/131.1

(57) ABSTRACT

The invention relates to a two-colored or multi-colored foam foil (50) on the basis of thermoplastic synthetic material, comprising at least one top layer and one sub-layer, whereby the sub-layer constitutes a foam layer (17) and the top layer exists in the form of a two-colored or multi-colored compact foil (4) of a carrier (15) and at least one additional layer (16), whereby the additional layer(s) (16) are surface-flush arranged in a corresponding recess (19) of the carrier (15) and both, carrier (15) as well as the additional layer(s) (16) each form a portion of the surface of the foil and are colored a different color. The invention relates, moreover, to a method as well as a device for the manufacture of the invention-specific two-colored or multi-colored foam foil (50).

The invention relates to a two- or multi-colored foam foil, as well as a method and a device for its manufacture.

Foam foils have long been known in the state of the art. They must specifically satisfy the applicable requirements in the automobile industry, where they serve for covering parts of vehicle interiors, in particular parts of automobile interiors, such as side doors, gear shifting consoles, dash-board padding, columns, sides of back rests, ceiling parts, dashboard instrument panels, and similar. The known foam layers generally are composed of a plasticizer-containing PVC foam and a compact top- or decorative layer. Aside from adequate mechanical properties in regard to strength of material against wear and tear, such as scratching, knocking, rubbing or similar, the requirements desired by the automobile and/or vehicle manufacturers are aimed at the laminated components having a certain soft-padding effect and that the surface, when touched, has a pleasant touch. In particular, aesthetic considerations play a significant role in this case, that is to say, the visual appearance within the vehicle is of importance.

Thus, with respect to the lining of instrument panels, the upper part is usually designed in a dark color, i.e. black, so that it will not produce a reflective image in the wind shield and impair the driver's field of vision.

The lower part of the instrument panel, on the other hand, is mostly designed in light colors, for aesthetic reasons. Consequently, two differently dyed components must be processed separately and subsequently assembled. This step is time-consuming and incurs additional costs. The situation is similar with respect to interior door linings, according to which a dark upper part and a light lower part are wanted.

Two-colored gear shift panel sheets or dash-board panel sheets are known in the state of the art, as described for example in DE 195 30 757 A1 or DE 197 36 194 A1. The known foam foils, however, are only in one color. Two- or multi-colored foam sheets, which satisfy the desired requirement profiles are currently not obtainable on the market. This is due to different factors. If one were to laminate onto a known foam sheet of customary thickness, a known two- or multi-colored top layer, one would obtain a foam foil which could not be further processed and which, moreover, would not satisfy any of the specifications required with respect to foam foils. The reason for this is, on the one hand, that the entire foam sheet would present too great a total thickness, as a result of which, when applying the foam sheet to the components for interior paneling in motor vehicles, it is no longer possible to obtain defined radiuses. If one were to laminate a two- or multi-colored top sheet onto a foam sheet, the thickness of the multi-colored top sheet would be too bulky, which would destroy the soft effect and pleasant feel to the touch which is desired from a foam sheet. In other words, the excessively thick colored top layer hampers the soft-elastic feel of the foam sheet. However, based on the limitations in process engineering, it is not possible to manufacture multi-colored sheets in any optionally selected thickness.

Another drawback of known two- or multi-colored sheets consists in that two sheets of different colors are laminated for example on a carrier, whereby the two colored sheets are next to each other or overlap at the locations where they abut or where they are sewn together. If the sheets are located directly next to each other, an additional border area is created, which constitutes during shaping of the two- or multi-colored sheets a weak spot insofar as stability is concerned, i.e. for example, during deep-drawing, the sheet easily breaks at this seam location and tears. With respect to the variation where the two colored sheets overlap at the seam, it is possible to also incur problems of adhesion, in particular if the lower color layer carries an additional layer of varnish, so that the overlapping region will likewise easily split open and/or tear open while shaping is taking place.

In addition, it is necessary, aside from compatibility problems between the colored layer and the foam layer, to also take into consideration the requirements of the automobile industry. It is therefore necessary to adjust the technology on the one side relative to a two- or multi-colored layer and on the other side relative to a foam foil in such fashion so that readily processable foam foils are obtained as a result, which have the specified requirements.

Taking the above background into account, it is the object of the invention to provide two- or multi-colored foam sheets, which avoid the above described drawbacks, which satisfy the requirements of the automobile industry and which can be employed specifically for lining of instrument panels and/or lining of interior doors. In addition, the foam sheet is to be manufacturable in economical and simple fashion, without high consumption of time and cost.

According to the invention, the above object in solved by a two- or multi-colored foam sheet made of thermoplastic material, comprising at least one top-layer and one under-layer, whereby the under-layer constitutes a foam layer and the top-layer is present in form of a two or multi-colored compact sheet consisting of a carrier and at least one additional layer, whereby the additional layer(s) is/are arranged in a corresponding recess of the carrier, flush with its surface, and the carrier as well as additional layer(s) each form part of the surface of the sheet and are dyed differently.

Given consideration by way of foam materials are polyurethane foams or polyolefine foams, such as preferably polyethylene, polypropylene and a polymerisate mixture of same. The materials satisfy the named specifications, in particular, they are readily deformable by heat, they present excellent stability vis-a-vis temperature and they have an outstanding [shape] recovery property. They have a fine, regular and closed-cell structure, including the required excellent mechanical properties.

The thickness of the under-layer in form of the foam layer preferably amounts to approximately 0.7 to 8.0 mm, specifically approximately 1.0 to 4 mm.

On the foam layer of the invention-specific two- or multi-colored foam sheet is designed a top layer in form of a two- or multi-colored compact sheet. The compact sheet is composed of a support and at least one additional layer, whereby the additional layer(s) is/are arranged in a corresponding recess of the carrier and are level with its surface, and support as well as the additional layer(s) each form a part of the surface of the sheet and are dyed differently. Under “recess” is meant here any deviation from the rectangular shape of the thickness profile of the carrier. The recess can have, for example, the shape of a rectangular, trapezoidal or triangular indentation, with any other geometric shape of indentation likewise being included, which can be produced in a carrier. The recess can constitute one single, closed region of the carrier, but it can also pertain to several regions of the carrier which are separated from each other.

The top coat in form of the compact sheet therefore consists of a composite of carrier and at least one additional layer, whereby the additional layer is embedded in a recess of the carrier and is surface-flush with same, so that the surface of the compact foil is formed in part by the carrier and in part by at least one additional layer, each having a different color. Thus, two or more regions exist in the two-colored or multi-colored compact sheet, whereby each region may have a different color. One visible color originates from the carrier, with the additional color or additional colors belonging to the additional layers. The first color can be, for example, a dark shade, such as black or brown, while the second color can have a light tint, such as white or gray. Consequently, the carrier itself is visible in the two-colored or multi-colored compact sheet.

The thermoplastic synthetic materials of the two-colored or multi-colored compact sheet are not subject to any restriction within the scope of the invention. Suitable are for example polyolefines, vinylpolymers, polyamides, polyesters, polyacetates, polycarbonates and, in part, also polyurethanes. Particularly preferred are polyolefines. The compact sheet preferably has a thickness of approximately 0.2 to 1.5 mm, in particular approximately 0.3 to 0.7 mm.

According to a particularly preferred specific embodiment, the synthetic materials of the compact sheet comprising carrier and at least one additional layer are selected in such manner that these present comparable viscosities at like temperature. As a result, the composite of carrier and additional layer can be made more solid. It is also possible to select the carrier and the additional layer from the same thermoplastic synthetic. material, which, in the case of polyolefines, for example, drastically increases the recycling capability of same.

Preferred, according to the invention, is for the additional layer to have a thickness of approximately 0.2 to 1.0 mm, in particular approximately 0.3 to 0.6 mm. In this case, it is possible to appropriately adjust the thickness of the carrier and of the additional layer in order to obtain a two-colored or multi-colored compact sheet having the desired thickness. Within the scope of the invention, it is possible to make available very thin, two-colored or multi-colored compact sheets, which was impossible according to the initially described state of the art. These very thin-walled compact sheets nevertheless provide also the specified solidity and other desired mechanical properties.

With respect to employable color-providing pigments for the two-colored or multi-colored compact foil, the invention likewise is not subject to restriction. Thus, it is possible to obtain the multi-coloration of the invention-specific foam sheet by appropriately differentiated color pigmentation or introduction of coloring material to the melted plastic material of the carrier and the additional layer or layers. The quantities of added pigment are within traditional ranges and are known to a person in this field who is skilled in the art. Needless to say, additional customary additives may be present in the layers.

The two-colored or multi-colored compact sheet is applied in traditional fashion onto the foam sheet or foam layer. For said purpose, any method known to the expert may be employed.

Subject matter of the invention is also a method for the manufacture of the two-colored or multi-colored foam sheet on the basis of a thermoplastic synthetic material, whereby three variations may be employed according to the invention:

According to a first process variation, the two-colored or multi-colored foam sheet on the basis of a thermoplastic synthetic material is manufactured according to the following steps:

(1) Preparation and/or provision of a carrier on the basis of a thermoplastic synthetic material of a first color with formation of at least one indentation in the thickness profile of the carrier;

(2) Preparation and/or provision of at least one additional layer having a different color than the carrier, said layer is embedded into the indentation of the carrier and is flush with the surface, and joining the layers under the effect of heat and pressure, with simultaneous smoothing-out of the developing surface while forming a top layer in form of a two-colored or multi-colored compact sheet;

(3) if appropriate, varnishing the surface of the top layer and

(4) laminating the top layer onto a foam layer, with simultaneously embossing the top layer, if necessary.

According to the invention, the second process variation for preparation of a two-colored or multi-colored foam sheet relates to the following steps:

(1) Preparation and/or provision of a carrier on the basis of a thermoplastic synthetic material of a first color with formation of at least one indentation in the thickness profile of the carrier;

(2) Preparation and/or provision of at least one additional layer having a different color than the carrier, said layer is embedded into the indentation of the carrier and is flush with the surface, and joining the layers under the effect of heat and pressure, with simultaneous smoothing-out the developing surface while forming a top layer in form of a two-colored or multi-colored compact sheet;

(3) if appropriate, varnishing and embossing the surface of the top layer and

(4) laminating the top layer onto a foam layer using an adhesive.

In the two aforementioned process variations of the invention according to steps (1) and (2), a two-colored or multi-colored compact sheet is first prepared and/or supplied. The carrier as well as the additional layers can be prepared by means of extrusion, for example. At least one additional layer is added to the carrier and fitted and/or embedded into the corresponding recess of the carrier, under the effect of heat and pressure, with concurrent smoothing-out of the developing surface. The carrier and the additional layer present one other color, which produces the multi-colored appearance. Needless to say, it is also possible to combine several layers of differently colored plastic materials. Subsequently, in step (3) the surface of the top layer can receive the appropriate treatment, for example by means of varnishing and/or embossing, whereupon, in step (4) lamination onto the foam layer or foam sheet takes place and also additional embossing, if appropriate. It is also possible to smooth-out the surface of the top layer at least one more time.

In the two above process variations a two-colored or multi-colored compact sheet is first produced, which is subsequently laminated onto a foam sheet and foam layer. This may be done by methods known according to the state of the art.

The bonding by means of adhesive according to the second variation can be done with a conventional glue, but also by means of an adhesive foil, in particular such as a heat-fusible foil. Particularly preferred is an adhesive layer which flatly and permanently bonds the top layer to the foam layer, having thermoplastic character and being very thin. This may involve, for example, a single-layer or multiple-layer heat-fusible foil. This foil should preferably be no thicker than 0.2 mm. A single-layer and/or multi-layer adhesive layer with solvent-adhesive or dispersion adhesive and/or a combination of both can also be utilized.

Due to the fact that the carrier is likewise colored according to the invention, at least one extruder can be saved in the process, which results in lower expenditures and an easier to be controlled method for the preparation of the invention-specific two-colored or multi-colored foam sheet. Based on process control according to the invention when producing the two-colored or multi-colored compact sheet, lower reject volume is achieved, which is based, among other reasons, on the low number of border areas vis-a-vis known two-color or multi-color foils, which have, due to the seam location, where the colored sheets abut or overlap, a kind of highly susceptible break-down location when the sheet is being shaped or subjected to stress. The occurrence of manufacturing defects is clearly decreased as a result. The obtained foam sheet of the invention presents, overall, an improved resistance when in use and during further processing, since the sources for errors are reduced because of minimal overlap and border areas. In fact, the two-colored or multi-colored compact sheet on top of the foam sheet behaves like a conventional homogeneous single-color sheet and, consequently, also enjoys its benefits.

According to a third process variation, a two-colored or multi-colored foam sheet on the basis of a thermoplastic synthetic material is prepared by means of the following process steps:

(1) Preparation and/or provision of a carrier (15) on the basis of a thermoplastic synthetic material of a first color with formation of at least one indentation (19) in the thickness profile of the carrier (15), which fits into the indentation;

(2) Preparation and/or provision of at least one additional layer (16) having a different color than the carrier (15);

(3) Provision of a foam layer (17);

(4) Joining of carrier (15), additional layer(s) (16) and foam layer (17). Bonding of layers under the effect of heat and pressure with concurrent smoothing of the developing surface while forming a two-colored or multi-colored foam sheet (50) and

(5) varnishing and embossing of the surface of the top layer, if appropriate.

According to said third variation of the invention-specific method, the compact sheet is not first produced and then further processed into the foam sheet, but the two-colored or multiple-colored foam sheet is directly prepared from all layers. To that end, all layers are brought together at the smoothing mechanism and are there joined with each other. Accordingly, the foam is permitted to to enter at the location where the carrier and the additional (layer(s) are supplied. The carrier and the additional layer(s) can be produced, for example, by means of extrusion. The layers are then appropriately laminated in the smoothing mechanism under the influence of heat and pressure. For joining the compact sheet with the foam sheet, an adhesive may, in addition, be beneficially employed, which will provide flat and permanent bonding in form of a traditional glue or an adhesive layer.

According to the invention, it is possible with respect to all three variations, to simultaneously prepare the carrier and the additional layer(s) of the two-colored or multi-colored compact sheet and with provision of the foam layer, get directly to the invention-specific foam foil. Of course, the individual layers or sheets can also be produced separately and be employed as semi-finished products and then processed further into the foam sheet.

It has been proven appropriate in the method of the invention to preheat at least one of the sheets or layers to a temperature ranging from approximately 50 to 250° C. prior to the assembly and bonding step. The temperature can be selected based upon the properties of the sheet to be treated, such as thickness and type of the thermoplastic synthetic material—an IR-radiation field may be employed for that purpose.

The sheets and layers have the already described specifications and compositions. Needless to say, traditional additives may be incorporated in same.

According to a particularly preferred specific embodiment, the joining of the carrier with differently colored layer(s) takes place in the three invention-specific process variations outside the extruder nozzles. In other words it is not absolutely necessary that carrier and additional layers be co-extruded, but that is, however, possible.

The invention relates to a device for the manufacture of a two-colored or multi-colored foam sheet, comprising:

a first device for producing and/or providing a layer of synthetic material for developing a carrier with a first color, having at least one recess:

a second device for producing and/or providing at least one additional layer of synthetic material for forming one or several additional layer(s) with a different color than the carrier, which fit into the recess(es) flush with the surface of the carrier;

a third device for provision of a foam layer;

a smoothing mechanism for flat surface-bonding and smoothing of the developed surface

(a) of the carrier, the additional layer(s) and the foam layer, while developing a two-colored or multi-colored foam sheet or

(b) of the carrier and the additional layer(s) while developing a two-colored or multi-colored compact sheet and

a fourth device for joining the two-colored or multi-colored compact sheet obtained according to (b) with the foam layer, while developing a two-colored or multi-colored foam sheet.

Accordingly, the invention-specific device can have a first device, such as for example an extruder for creating a carrier, and also at least one additional device, such as for example a second extruder for creating the additional layer with a second color, said carrier and layer being respectively formed by an appropriate molding tool of the extruder. The first and second device may also serve for supply of carrier and an additional layer only, in other words, previously prepared layers or sheets are employed. The previously prepared additional layer is then fitted in the recess, flush with the surface of the carrier.

According to a preferred specific embodiment, carrier and additional layer(s) are produced by extrusion, whereby the molding tool of the first extruder preferably presents a slot-like nozzle, into which protrudes a projection whose cross-section extending cross-wise relative to the flow direction of the melted plastic material, corresponds to the recess cross-section of the producing carrier. It is possible by way of appropriate adjustment of the projection to correspondingly adjust the shape and dimension of the recess in the carrier. Thus, the projection can, for example, be in the shape of a relatively extended lip or undulation. For regulation of thickness and width of the recess, the lip may be designed so that it is adjustable in height and/or length. Also, in the first device, adjustable means may be provided, for example, in form of adjustable lips which permit variation of carrier thickness and thus of the totality in thickness of the top layer. The molding tool of the second extruder, for example in shape of a nozzle, may also be designed adjustably, in order to appropriately dimensioning the additional layer(s) for the selected dimensions of the recess in the carrier.

Moreover, according to the invention, a third device is present for supply of a foam layer.

In addition, the device of the present invention presents a smoothing-out mechanism. According to the specific embodiment (a) according to the invention, same serves for flat surface joining and smoothing-out the developed surface of the carriers, at least one additional layer and the foam layer, while developing a two-colored or multi-colored foam sheet. Alternatively, the smoothing-out mechanism serves for flat surface joining and smoothing-out the developed surface of the carrier and the additional layers while first developing a two-colored or multi-colored compact foil, which is subsequently processed, with supply of the foam layer, in a fourth device, into the invention-specific two-colored or multi-colored foam foil.

According to a preferred embodiment, an additional device is provided for preheating of at least one of the foils or layers before the smoothing mechanism, whereby prior to the assembly and bonding step, preheating takes place to a temperature ranging between approximately 50 to 250° C.

The benefits afforded by the invention are multifarious. The invention-specific two-colored or multi-colored foam foil distinguishes itself by a multitude of beneficial properties. It can be processed without problems, it satisfies the desired specifications and can be economically produced in simple manner. Aside from its outstanding processing capability, the foam foil offers two-colored or multi-colored design, which thus far has not been available according to the state of the art.

With employment of the invention-specific foam foil, additional processing steps can be eliminated, since components of different color need no longer be separately processed and subsequently assembled. This avoids incurring additional costs.

Aside from its aesthetic appearance and pleasing image, the two-colored or multi-colored foam foil provides the desired excellent padding effect as well as an excellent (shape) recovery capability of known foam foils and presents a beneficially low weight. Overall, the two-colored or multi-colored foam foil satisfies in high degree the specifications set by the automobile industry.

Beneficial specific embodiments and improvements of the present invention are evident from the description which follows with respect to the attached drawings.

The drawings show:

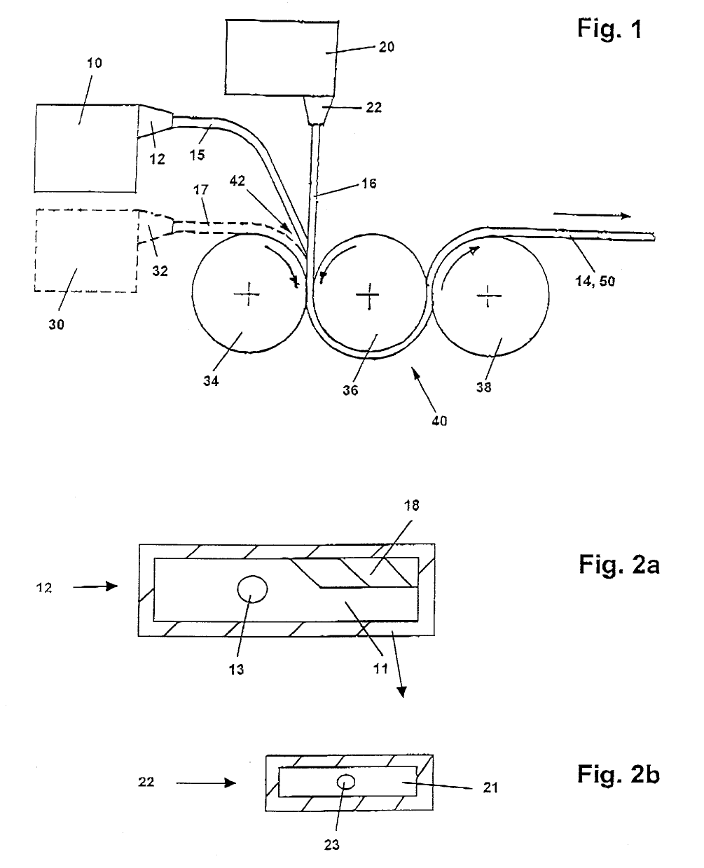

FIG. 1 a schematic lateral view of a specific embodiment of the device according to the invention;

FIG. 2a a schematic cross-section of a first molding tool of a first extruder of the invention-specific device according to FIG. 1;

FIG. 2b a schematic cross-section of a second molding tool of a second extruder of the invention-specific device according to FIG. 1;

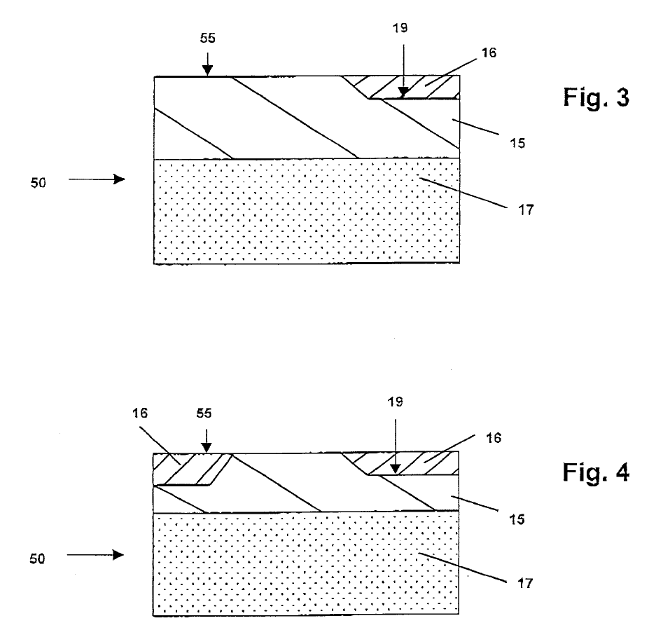

FIG. 3 a specific embodiment of the layered structure of the invention-specific two-colored or multi-colored foam foil and

FIG. 4 another specific embodiment of a layered structure of the invention-specific two-colored or multi-colored foam foil.

FIG. 1 shows a specific embodiment of the invention-specific device, which, essentially, comprises a first extruder 10 with a first molding tool 12, a second extruder 20 with a second molding tool 22 and a smoothing mechanism 40. Said section of the invention-specific device indicates in schematic fashion a manufacturing variation of the two-colored or multi-colored compact foil, which is followed by lamination onto a foam layer (not shown).

In FIG. 1, a compact foil 14 is produced, composed of a carrier 15 and another layer 16. The molding mass of the first melted plastic material is extruded as carrier 15 by extruder 10 via a first molding tool 12 with integrated exit nozzle and/or wide-slot nozzle (not shown). The carrier 15 has a first color by means of corresponding pigmentation, which may represent, for example, a dark-tinted shade, such as black or brown.

The second extruder 20 can be built in identical fashion as extruder 10 and extrudes, with exit nozzle (not shown), a melted plastic mass or forming mass through a second molding tool 22, as additional layer 16, which has a second color of a different shade, which may be fighter than the first color.

The first molding tool 12, represented in cross-section in FIG. 2a, is arranged at the first extruder 10 and presents a shaping chamber 11, into which enters the melted plastic material from the extruder 10 via a conduit 13. Into chamber 11 protrudes a lip 18 as projection, which has a rectangular cross-section and which shapes the recess 19 in carrier 15 formed by the first molding tool 12.

Chamber 11 of the molding tool 12 changes over into an exit nozzle (not shown).

The second molding tool 22 of the second extruder 20, shown in cross-section in FIG. 2b, has a molding chamber 21, through which enters, via conduit 23 of extruder 20, the melted plastic material or shaping mass. Chamber 21 changes over into the exit nozzle (net shown) of molding tool 22. The rectangular, clear cross-section of chamber 21 of the second molding tool 22 is adjusted to or congruent with the lip 18 protruding into chamber 11 of the first molding tool 12. The second molding tool 22 produces the additional layer 16 with rectangular slot-like profile.

The smoothing mechanism 40 comprises three rotating rolls 34, 36 and 38, arranged next to each other. The rotational direction of the rolls can be learned from FIG. 1, indicating the appropriate arrows. In the depicted specific embodiment, the carrier layer 15, extruded by extruder 10 and the molding tool 12, is passed to the charging gap 42. Layer 16, extruded by the second extruder 20 and the second molding tool 22 is passed from above, vertically, to the charging gap 42. The second molding tool 22 is arranged in such fashion that the additional layer will enter, properly positioned and adapted to carrier 15, into charging gap 42 between the first roll 34 and the second roll 36, whereby the additional layer 16 enters exactly congruently into the rectangular recess 19 of carrier 15.

The first roll 34 and the second roll 36 continue to transport the two-colored or multi-colored compact foil, composed of carrier 15 and additional layer 16, until the composite foil leaves the smoothing mechanism 40 again, via the third roll 38, which rotates in clock-wise direction. Due to the prevailing temperature in the smoothing mechanism, ranging between approximately 40 and 90° C., and the pressure exerted by the rolls, the partially still heated foils are fused together to a firm composite, or are glued together and, concurrently, the surface of the compact foil is smoothed out.

As a result, it is possible to simultaneously with the manufacture of the carrier 15, produce a layer 16 by means of extrusion and molding in such manner that the layer will fit congruently into the recess 19 of carrier 15. The fusion of carrier 16 and layer 16 is performed in the area of the charging gap 42 of the smoothing mechanism 40, whereby layer 16 is introduced, properly positioned, into the recess 19 of carrier 15.

Behind the extruder fixture and before the smoothing mechanism, a device may be provided for preheating of the respective foil or layer, in order to properly prepare same for the subsequent process of bonding and/or gluing.

After leaving the smoothing mechanism, the two-colored or multi-colored compact foil can, following application of varnish to the surface—if appropriate—be laminated in another device (not shown) onto a foam layer 17. Concurrently, the surface of the compact foil may be embossed. According to the invention, it is also possible to join the two-colored or multi-colored compact foil with the foam layer 19 by means of glue or an adhesive foil. The foam layer 17 can be supplied, simultaneously produced with the compact foil or also as semi-finished product.

According to another preferred specific embodiment, another device 30 (shown in dotted fashion in the drawing) may be provided for supply of the foam layer 17. The foam layer 17 initially extends in horizontal plane and is then picked up by the first roll 34 and passed, resting on its circumference, to the charging gap 42. This permits placing the carrier and the additional layer 16 and the foam 17 against each other in the charging gap 42 of the smoothing mechanism 40, thus directly forming the two-colored or multi-colored foam foil 50. Of course, it is also possible to already combine the layers or foils immediately after molding, prior to entry into the charging gap 42.

FIGS. 3 and 4 show different specific embodiments of an invention-specific two-colored or multi-colored foam foil 50 on the basis of a thermoplastic synthetic material, whereby the carrier 15 and the compact foil 14 each extend up to the surface 55 of the compact foil 14 and the additional layer 16 is fitted into the recess 19 of the carrier 15 and likewise extends up to the surface 55 of the compact foil 14. Below the two-colored compact foil 14, in form of the top layer, there is provided a sub-layer in form of the foam layer 17.

In the above arrangements, the additional layer 16 and the carrier 15 are arranged, surface-flush, at the top-side 55 of compact foil 14. As a result, the invention-specific foam foil 50, with the carrier 15 having a first color, and the layer 16 having a second color, gives the viewer the appearance of a two-colored design.

1. Two-colored or multi-colored foam foil (50) on the basis of thermoplastic synthetic material, comprising at least one top layer and one sub-layer, with the sub-layer constituting a foam layer (17) and the top layer existing in form of a two-colored or multi-colored compact foil (14), of a carrier (15) and at least one additional layer (16), whereby the additional layer(s) is/are arranged in a corresponding recess (19) of the carrier (15), surface-flush with same, and carrier (15) as well as additional layer(s) respectively form part of the surface of the foil and are colored differently.

2. Foam foil according to claim 1, characterized in that the two-colored or multi-colored compact foil (14) is laminated onto the foam layer (17).

3. Foam foil according to claim 1 or 2, characterized in that the foam layer (17) constitutes a polyurethane- or polyolefine foam, whereby, in particular, the polyolefine foam is composed of polyethylene and/or polypropylene.

4. Foam foil according to one of claims 1 to 3, characterized in that the compact foil (14) presents a thickness of approximately 0.2 to 0.5 mm, specifically approximately 0.3 to 0.7 mm.

5. Foam foil according to one of claims 1 to 4, characterized in that the additional layer (16) presents a thickness of approximately 0.2 to 1.0 mm, specifically approximately 0.3 to 0.6 mm.

6. Foam foil according to at least one of claims 1 to 5, characterized in that the foam layer (17) presents a thickness of approximately 0.7 to 8.0 mm, specifically approximately 1.0 to 4 mm.

7. Foam foil according to at least one of claims 1 to 6, characterized in that the additional layer (16) presents the same dimensions as the rectangular shape of the recess (19) in carrier (15).

8. Method for manufacture of a two-colored or multi-colored foam foil on the basis of thermoplastic synthetic material according to one of claims 1 to 7, with the following process steps:
(1) Manufacture and/or provision of a carrier (15) on the basis of thermoplastic synthetic material of a first color with formation of at least one recess (19) in the thickness profile of the carrier (15);
(2) Manufacture and/or provision of at least one additional layer (16,) colored in a different color from the carrier (15), which is fitted into the recess (19) of the carrier (15) in surface-flush manner and bonding of the layers under the effect of heat and pressure, with simultaneous smoothing of the developing surface while forming a top layer in form of a two-colored or multi-colored compact foil (14);
(3) varnishing of the surface of the top layer, if appropriate and
(4) lamination of the top layer onto a foam layer (17), with simultaneous embossing of the top layer, if appropriate.

9. Method for the manufacture of a two-colored or multi-colored foam foil on the basis of thermoplastic synthetic material according to one of claims 1 to 7, with the following process steps:
(1) Manufacture and/or provision of a carrier (15) on the basis of thermoplastic synthetic material of a first color with formation of at least one recess (19) in the thickness profile of the carrier (15).
(2) Manufacture and/or provision of at least one additional layer (16) colored in a different color from the carrier (15), with said layer being fitted in surface-flush fashion into the recess (19) of the carrier, and joining of layers under the influence of heat and pressure with simultaneous smoothing of the developing surface, while forming a top layer in the form of a two-colored or multi-colored compact foil (14);
(3) varnishing and embossing of the surface of the top layer, if appropriate, and
(4) lamination of the top layer onto a foam layer (17) using an adhesive.

10. Method for the manufacture of a two-colored or multi-colored foam foil on the basis of a thermoplastic synthetic material according to one of claims 1 to 7, with the following process steps:
(1) Manufacture and/or provision of a carrier (15) on the basis of a thermoplastic synthetic material having a first color with formation of at least one recess (19) in the thickness profile of the carrier (15), which fits into the recess;
(2) Provision of at least one additional layer (16) which is colored differently from the carrier (15);
(3) Provision of a foam layer (17);
(4) Uniting the carrier (15), the additional layer(s) 16 and the foam layer (17) joining the layers under the influence of heat and pressure, with simultaneous smoothing of the developing surface while forming a two-colored or multi-colored foam foil (50) and
(5) varnishing and embossing of the surface of the top layer, if appropriate.

11. Method according to at least one of claims 8 to 10, characterized in that the carrier (15) and the additional layer (16) of the top layer are produced at the same time and the two-colored or multi-colored foam foil (50) is produced with provision of the foam layer (17).

12. Method according to at least one of claims 8 to 11, characterized in that the additional layer (16) presents the same dimensions as the recess (19) in the carrier (15).

13. Method according to at least one of claims 8 to 12, characterized in that a polyurethane foam or a polyolefine foam is utilized as foam layer (17), whereby the polyolefine foam, in particular, constitutes a polyethylene foam and/or a polypropylene foam.

14. Method according to at least one of claims 8 to 13, characterized in that the carrier (15) and the additional layer(s) (16) are extruded.

15. Method according to at least one of claims 8 to 14, characterized in that at least one of the foils or layers is preheated to a temperature in the range of approximately 50 to 250° C., prior to the step of assembly and bonding.

16. Method according to at least one of claims 8 to 15, characterized in that a top layer is utilized having a thickness of approximately 0.2 to 1.5 mm, preferably approximately 0.3 to 0.7 mm.

17. Method according to at least one of claims 8 to 16, characterized in that a foam layer (17) is utilized having a thickness of approximately 0.7 to 0.8 mm, preferably approximately 1.0 to 4 mm.

18. Method according to at least one of claims 8 to 17, characterized in that the bonding of the carrier (15) with the differently colored layer(s) (16) takes place outside the nozzles of the extruder.

19. Device for the manufacture of a two-colored or multi-colored foam foil, comprising:
a first device for producing and/or supplying a synthetic material layer for the formation of a carrier (15) having a first color, with at least one recess (19);
a second device for the manufacture and/or provision of at least one additional synthetic material layer for the formation of one or several additional layers (16) having a different color than the carrier (15), said layers fitting surface-flush into the recess(es) (19) of the carrier (15);
a third device for provision of a foam layer (17),
a smoothing mechanism for flat-surface bonding and smoothing of the developed surface of
(a) the carrier (15), the additional layer(s) 16) and the foam layer (17) while forming a two-colored or multi-colored foam foil (50) or
(b) the carrier (15) and the additional layer(s) (16) while forming a two-colored or multi-colored compact foil (14) and
a fourth device for joining the two-colored or multicolored compact foil (14) obtained according to (b) with the foam layer (17) while forming a two-colored or multi-colored foam foil (50).

20. Device according to claim 19, characterized in that the first and the second device are extruders.

21. Device according to claim 20, characterized in that the joining of the carrier (15) with the foil or foils or layers (16) of a different color takes place outside the nozzles of the extruder.

22. Device according to at least one of claims 19 to 21, characterized in that means for varnishing and embossing of the top layer are provided before the third device.

23. Device according to one of claims 19 to 22, characterized in that means are provided before the third device for varnishing and within the third device means for embossing.

24. Device according to at least one of claims 19 to 23, characterized in that the first device presents adjustable means in order to vary the shape and size of the recess(es) (19) in the carrier (15).

25. Device according to at least one of claims 19 to 24, characterized in that the first device presents adjustable means in order to vary the thickness of the carrier (15) and thus the overall thickness of the top layer.

26. Device according to at least one of claims 19 to 25, characterized in that means are provided, before the smoothing mechanism, for pre-heating at least one of the foils or layers to a temperature in the range of 50 to 250° C.
